(19) United States
(12) Patent Application Publication
(10) Pub. No.: US 2025/0225422 A1
(43) Pub. Date: Jul. 10, 2025

(54) TUNABLE DIFFERENTIAL COUPLERS

(71) Applicant: International Business Machines Corporation, Armonk, NY (US)

(72) Inventor: Joseph Robert Suttle, Chappaqua, NY (US)

(21) Appl. No.: 18/409,367

(22) Filed: Jan. 10, 2024

(51) Int. Cl. G06N 10/40; G06N 10/20; H01P 5/00

(52) U.S. Cl. CPC G06N 10/40; G06N 10/20; H01P 5/00

(57) ABSTRACT

A device comprises a superconducting quantum circuit comprising a coupler which is coupled to a first quantum bit and a second quantum bit. The coupler comprises a tunable coupler and a fixed coupler. The coupler is configured to operate in a first mode to suppress coupling between the first quantum bit and the second quantum bit, when the tunable coupler is tuned to have a first frequency which corresponds to a fixed frequency of the fixed coupler. The coupler is configured to operate in a second mode to enable coupling between the first quantum bit and the second quantum bit, when the tunable coupler is tuned to have a second frequency which is different from the fixed frequency of the fixed coupler.

### BACKGROUND

This disclosure relates generally to superconducting quantum computing systems and, in particular, to tunable couplers for controlling interactions between superconducting quantum bits. A quantum computing system can be implemented using superconducting circuit quantum electrodynamics (cQED) architectures that are constructed using quantum circuit components such as, e.g., superconducting quantum bits and other types of superconducting quantum devices that are controlled using microwave and/or flux bias control signals. In general, superconducting quantum bits (qubits) are electronic circuits which are implemented using components such as superconducting tunnel junctions (e.g., Josephson junctions), superconducting quantum interference devices (SQUIDs), inductors, and/or capacitors, etc., and which behave as quantum mechanical anharmonic (non-linear) oscillators with quantized states when cooled to cryogenic temperatures. A qubit can be effectively operated as a two-level system in a computational subspace comprised of a ground state |0 [symbol] and a first excited state |1 [symbol] of the qubit, due to the anharmonicity imparted by a non-linear inductor element (e.g., Josephson junction inductance) of the qubit. The anharmonicity of a qubit allows the ground and the first excited states to be uniquely addressed at a transition frequency of the qubit, without significantly disturbing higher excited states of the qubit (e.g., |2 [symbol] , |3 [symbol] etc.).

Various types of quantum information processing algorithms can be implemented using a superconducting quantum processor which comprises multiple superconducting qubits which can be coherently controlled, placed into quantum superposition states, exhibit quantum interference effects, and become entangled with one another, by applying various types of quantum gate operations (e.g., single-qubit gate operations, two-qubit gate operations, etc.) to the superconducting qubits. The fidelity of quantum gate operations can be adversely impacted by unwanted crosstalk (e.g., residual static ZZ interactions) between superconducting qubits. For example, unwanted crosstalk between superconducting qubits can cause the transition frequency of one superconducting qubit to be dependent on the state of one or more neighboring superconducting qubits. As quantum processors are scaled with increasing numbers of superconducting qubits and higher integration densities, such unwanted crosstalk becomes increasingly problematic.

For large-scale quantum computation, a qubit array or qubit lattice can implement tunable couplers to dynamically control qubit-qubit interactions. For example, a flux-controlled tunable coupler has a tunable coupler frequency which can be adjusted to, e.g., suppress coupling between superconducting qubits, or facilitate qubit-qubit coupling between superconducting qubits to enable coupler-mediated two-qubit gate operations. While tunable couplers provide a mechanism for implementing high-fidelity two-qubit gate operations, the tunable couplers can provide undesired pathways which enable stray/spurious couplings to/from next nearest neighbor qubits (or spectator qubits), leading to spectator induced errors in the qubit array.

### SUMMARY

Exemplary embodiments of the disclosure include tunable couplers that are configured to control interactions between superconducting qubits. For example, an exemplary embodiment includes a device which comprises a superconducting quantum circuit comprising a coupler which is coupled to a first quantum bit and a second quantum bit. The coupler comprises a tunable coupler and a fixed coupler. The coupler is configured to operate in a first mode to suppress coupling between the first quantum bit and the second quantum bit, when the tunable coupler is tuned to have a first frequency which corresponds to a fixed frequency of the fixed coupler. The coupler is configured to operate in a second mode to enable coupling between the first quantum bit and the second quantum bit, when the tunable coupler is tuned to have a second frequency which is different from the fixed frequency of the fixed coupler.

Advantageously, the implementation of a coupler which comprises two separate resonant mode couplings (via a tunable coupler and a fixed coupler) to modulate a coupling between two quantum bits, allows the frequencies of the tunable coupler and the fixed coupler to be made degenerate (i.e., the same or substantially the same) to cause interference of the resonant mode couplings and thereby effectively cancel the coupling between the two quantum bits.

Another exemplary embodiment includes a device which comprises a superconducting quantum circuit comprising a coupler, a first quantum bit, and a second quantum bit. The coupler comprises a tunable coupler and a fixed coupler. The tunable coupler is differentially coupled to the first quantum bit, and differentially coupled to the second quantum bit. The fixed coupler is differentially coupled to the first quantum bit and differentially coupled to second quantum bit. One of the tunable coupler and the fixed coupler is differentially coupled to the first quantum bit and to the second quantum bit with opposite polarities, and the other of the tunable coupler and the fixed coupler is differentially coupled to the first quantum bit and to the second quantum bit with a same polarity.

Another exemplary embodiment includes a system which comprises a superconducting quantum circuit and a control system. The superconducting quantum circuit comprises a coupler which is coupled to a first quantum bit and a second quantum bit. The coupler comprises a tunable coupler and a fixed coupler. The control system is configured to cause the coupler to operate in one of a first mode and a second mode. In the first mode, the control system causes the tunable coupler to have a have a first frequency which corresponds to a fixed frequency of the fixed coupler, to thereby suppress a coupling between the first quantum bit and the second quantum bit. In the second mode, the control system causes the tunable coupler to have a second frequency which is different from the fixed frequency of the fixed coupler, to thereby enable a coupling between the first quantum bit and the second quantum bit.

Another exemplary embodiment includes a system which comprises a quantum processor and a control system. The quantum processor comprises a lattice of superconducting quantum bits and couplers that are configured to control interactions between the superconducting quantum bits. The control system is configured to generate control signals for controlling the superconducting quantum bits and for controlling the couplers. The superconducting quantum bits and the couplers comprise at least one coupler which is coupled to at least a first quantum bit and a second quantum bit, and which comprises a tunable coupler and a fixed coupler. The at least one coupler is configured to operate in a first mode to suppress coupling between the first quantum bit and the second quantum bit, when the tunable coupler is tuned in response to a first control signal from the control system to have a first frequency which corresponds to a fixed frequency of the fixed coupler. The at least one coupler is configured to operate in a second mode to enable coupling between the first quantum bit and the second quantum bit, when the tunable coupler is tuned in response to a second control signal from the control system to have a second frequency which is different from the fixed frequency of the fixed coupler.

Another exemplary embodiment includes a method which comprises tuning a coupler to operate in one of a first mode and a second mode to control an amount of coupling between a first quantum bit and a second quantum bit, the coupler comprising a tunable coupler and a fixed coupler, wherein tuning the coupler to operate in the first mode comprises tuning the tunable coupler to have a first frequency which corresponds to a fixed frequency of the fixed coupler to suppress the coupling between the first quantum bit and the second quantum bit, and wherein tuning the coupler to operate in the second mode comprises tuning the tunable coupler to have a second frequency which is detuned from the fixed frequency of the fixed coupler to enable a coupling between the first quantum bit and the second quantum bit.

In another exemplary embodiment, as may be combined with the preceding paragraphs, in the second mode, the second frequency of the tunable coupler corresponds to a transition frequency of the first quantum bit or the second quantum bit.

In another exemplary embodiment, as may be combined with the preceding paragraphs, the coupler is configured to suppress a direct capacitive coupling between the first quantum bit and the second quantum bit, when the coupler operates in the first mode or the second mode.

In another exemplary embodiment, as may be combined with the preceding paragraphs, in the first mode, the coupler is configured to suppress the coupling between the first quantum bit and the second quantum bit through cancellation of coupler-qubit couplings of the tunable and fixed couplers with the first and second quantum bits. In the second mode, the coupler is configured to enable coupling between the first quantum bit and the second quantum bit through a net effective coupler-qubit coupling of the tunable and fixed couplers with the first and second quantum bits.

In another exemplary embodiment, as may be combined with the preceding paragraphs, the tunable coupler is capacitively coupled to a differential mode of the first quantum bit with a first polarity, and to a differential mode of the second quantum bit with the first polarity, and the fixed coupler is capacitively coupled to the differential mode of the first quantum bit with the first polarity, and to the differential mode of the second quantum bit with a second polarity, which is opposite the first polarity.

In another exemplary embodiment, as may be combined with the preceding paragraphs, the fixed coupler is capacitively coupled to a differential mode of the first quantum bit with a first polarity, and to a differential mode of the second quantum bit with the first polarity, and the tunable coupler is capacitively coupled to the differential mode of the first quantum bit with the first polarity, and to the differential mode of the second quantum bit with a second polarity, which is opposite the first polarity.

In another exemplary embodiment, as may be combined with the preceding paragraphs, the tunable coupler is implemented with a flux-tunable quantum bit coupler, and the fixed coupler is implemented with a fixed frequency quantum bit coupler.

Other embodiments will be described in the following detailed description of exemplary embodiments, which is to be read in conjunction with the accompanying figures.

### BRIEF DESCRIPTION OF THE DRAWINGS

FIG. 1 schematically illustrates a superconducting quantum circuit comprising a tunable differential coupler that is configured to modulate a coupling between superconducting quantum bits, according to an exemplary embodiment of the disclosure.

FIG. 2A schematically illustrates an exemplary superconducting qubit which can be implemented in the superconducting quantum circuit of FIG. 1, according to an exemplary embodiment of the disclosure.

FIG. 2B schematically illustrates an exemplary tunable coupler which can be implemented in the superconducting quantum circuit of FIG. 1, according to an exemplary embodiment of the disclosure.

FIG. 3A schematically illustrates a superconducting quantum circuit comprising a tunable differential coupler that is configured to modulate a coupling between superconducting quantum bits, according to another exemplary embodiment of the disclosure.

FIG. 3B schematically illustrates a superconducting quantum circuit comprising a tunable differential coupler that is configured to modulate a coupling between superconducting quantum bits, according to another exemplary embodiment of the disclosure.

FIG. 4 is a flow diagram of a method for utilizing a differential coupler to modulate a coupling between superconducting qubits, according to an exemplary embodiment of the disclosure.

FIG. 5 schematically illustrates a qubit array comprising a plurality of qubits and tunable differential couplers that are configured to modulate couplings between qubits in the qubit array, according to exemplary embodiments of the disclosure.

FIGS. 6A and 6B depict simulated waveforms which show exemplary operating characteristics of a tunable differential coupler, according to an exemplary embodiment of the disclosure.

FIG. 7 schematically illustrates a quantum computing system, according to an exemplary embodiment of the disclosure.

FIG. 8 schematically illustrates an exemplary architecture of a computing node which can host a quantum computing platform, according to an exemplary embodiment of the disclosure.

### DETAILED DESCRIPTION

Exemplary embodiments of the disclosure will now be described in further detail with regard tunable differential coupler architectures and associated coupling techniques, which implement two separate resonant mode couplings (via a tunable coupler and a fixed coupler) to modulate a coupling between two data qubits, while effectively cancelling a direct capacitive coupling between the two data qubits bits to thereby eliminate stray/spurious coupling to/from spectator qubits.

It is to be understood that the various features shown in the accompanying drawings are schematic illustrations that are not drawn to scale. Moreover, the same or similar reference numbers are used throughout the drawings to denote the same or similar features, elements, or structures, and thus, a detailed explanation of the same or similar features, elements, or structures will not be repeated for each of the drawings. Further, the term “exemplary” as used herein means “serving as an example, instance, or illustration.” Any embodiment or design described herein as “exemplary” is not to be construed as preferred or advantageous over other embodiments or designs.

Moreover, it is to be understood that the terms “correspond to” or “degenerate” as used herein in the context of, e.g., comparing frequencies of quantum components such as couplers and qubits, means two frequencies are the same or substantially the same. For example, a first frequency which “corresponds to” a second frequency, or a first frequency which is “degenerate” with a second frequency, means that the first frequency and the second frequency are the same (e.g., equal) or substantially the same (e.g., nearly equal).

Further, it is to be understood that the phrase “configured to” as used in conjunction with a circuit, structure, element, component, or the like, performing one or more functions or otherwise providing some functionality, is intended to encompass embodiments wherein the circuit, structure, element, component, or the like, is implemented in hardware, software, and/or combinations thereof, and in implementations that comprise hardware, wherein the hardware may comprise quantum circuit elements (e.g., quantum processors comprising quantum bits and tunable couplers, etc.), control circuitry for controlling operation of quantum processors, discrete circuit elements (e.g., transistors, inverters, etc.), programmable elements (e.g., application specific integrated circuit (ASIC) chips, field-programmable gate array (FPGA) chips, etc.), processing devices (e.g., central processing units (CPUs), graphics processing units (GPUs), etc.), one or more integrated circuits, and/or combinations thereof. Thus, by way of example only, when a circuit, structure, element, component, etc., is defined to be configured to provide a specific functionality, it is intended to cover, but not be limited to, embodiments where the circuit, structure, element, component, etc., is comprised of elements, processing devices, and/or integrated circuits that enable it to perform the specific functionality when in an operational state (e.g., connected or otherwise deployed in a system, powered on, receiving an input, and/or producing an output), as well as cover embodiments when the circuit, structure, element, component, etc., is in a non-operational state (e.g., not connected nor otherwise deployed in a system, not powered on, not receiving an input, and/or not producing an output) or in a partial operational state.

As is known in the art, quantum computing provides a computing paradigm which utilizes fundamental principles of quantum mechanics to perform computations. Quantum computing algorithms and applications are defined using quantum circuits. A quantum circuit is a computational routine which defines coherent quantum operations that are performed on quantum data that is stored in quantum bits, in conjunction with operations that are performed using classical computation. Quantum circuits are utilized to define complex algorithms and applications in an abstract manner, which can be executed on a quantum computer which comprises, e.g., a superconducting quantum processor that comprises an array of superconducting qubits, such as transmon qubits, to generate and process quantum information. In a quantum computer, primitive operations comprise gate operations (e.g., single-qubit gate operations, two-qubit gate operations, multi-qubit gate operations (e.g., 3 or more qubits) that are applied to qubits, to perform quantum computing operations for a given application. The quantum circuits allow a quantum computer to receive classical data, perform quantum operations based on the received data, and output a classical solution.

As noted above, quantum computing systems can be configured to process quantum information that is encoded in a computational basis (|0 [symbol] or |1 [symbol] ) of qubits, wherein gate operations are performed using the two lowest energy levels of a qubit including a ground state |0 [symbol] and a first excited state |1 [symbol] . A single qubit can have a basis state of |0 [symbol] or |1 [symbol] , or a superposition state which comprises a linear combination of such basis states |0 [symbol] or |1 [symbol] . In addition, quantum information can be encoded through entangled basis states of multiple qubits. As noted above, various types of quantum gate operations can be implemented to place qubits into superposition states, or to place groups of qubits in entanglement states. In particular, in a superconducting quantum system, quantum superposition is a quantum-mechanical phenomena in which the quantum states of one or more qubits can superposed (i.e., added together) to produce another valid quantum state, wherein such a quantum state can be represented as a sum of the two or more distinct states. Further, in a superconducting quantum system, quantum entanglement is a quantum-mechanical phenomena in which a group of two or more qubits interact in such a way that the state of one qubit becomes intertwined with the states of the other qubits, wherein the quantum state of each qubit cannot be described independently (the quantum state is given for the group of entangled qubits as a whole).

As is known in the art, the state of a qubit can be graphically represented as a point on unit sphere (radius=1), which is called the Bloch sphere, with X, Y, and Z axes. The basis state |0 [symbol] (referred to as ground state) of a qubit is represented at a point (north pole) on a positive Z-axis of the Bloch sphere, while the basis state or |1 [symbol] (referred to as first excited state) of a qubit is represented at a point (south pole) on a negative Z-axis of the Bloch sphere.

A superposition state |ψ [symbol] of the qubit can be represented as a point on the Bloch sphere as follows:

$$\vert ψ 〉 = cos \frac{θ}{2} \vert 0 〉 + {e}^{i ϕ} sin \frac{θ}{2} \vert 1 〉 ,$$

where the terms

$$cos \frac{θ}{2}$$

and

$$sin \frac{θ}{2}$$

correspond to the amplitude probabilities associated with the respective states |0 [symbol] and |1 [symbol] , and wherein the term e^{iϕ} corresponds to a relative phase between the states |0 [symbol] and |1 [symbol] . The position of a point on the Bloch sphere representing a superposition state of a qubit is determined based on the angles θ and ϕ. The angle θ represents the angle from the positive Z axis (the |0 [symbol] state) to the positive X axis on the X-Z plane, where 0≤θ≤π. The angle ϕ represents the angle from the positive X axis (the |+ [symbol] state) to the positive Y axis on the X-Y plane, where 0≤ϕ≤2π. The angle θ influences the probability of observing a qubit state of |0 [symbol] or |1 [symbol] when the qubit is read, wherein the probability of reading a qubit state of |1 [symbol] increases as θ increases. The angle ϕ influences the relative phase between the states |0 [symbol] and |1 [symbol] . The state of a given qubit can be changed by applying a single-qubit gate operation to the given qubit, which causes the current state of the qubit to rotate around, e.g., the X-axis, Y-axis, and/or Z-axis, etc., depending on the given gate operation. A rotation about the Z-axis results in a change in the angle ϕ.

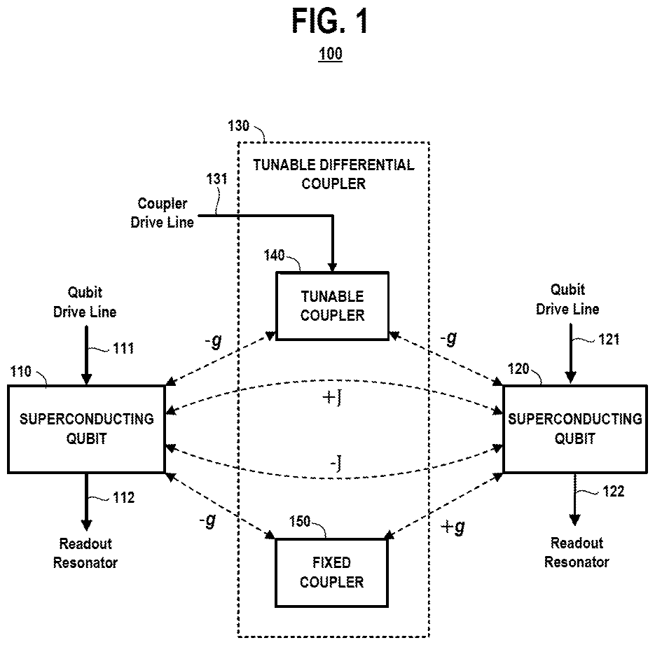

As noted above, for large-scale quantum computation, a quantum processor comprising an array of superconducting qubits can utilize tunable couplers to dynamically control qubit-qubit interactions. FIG. 1 schematically illustrates a superconducting quantum circuit comprising a tunable differential coupler that is configured to modulate a coupling of superconducting quantum bits, according to an exemplary embodiment of the disclosure. In particular, FIG. 1 schematically illustrates a superconducting quantum circuit 100 comprising a first superconducting quantum bit 110 (or first qubit 110), a second superconducting quantum bit 120 (or second qubit 120), and a tunable differential coupler 130 (or differential coupler 130). In the exemplary configuration, the first qubit 110 and the second qubit 120 comprise computational qubits (e.g., data qubits) which encode quantum information, and the differential coupler 130 differential coupler 130 is configured to control the coupling between the first and second qubits 110 and 120 and thus control the interaction between the first and second qubits 110 and 120 to perform gate operations.

In the exemplary configuration, differential coupler 130 implements two coupling modes to couple the first and second qubits 110 and 120. In particular, the differential coupler 130 comprises a first coupler 140 (or tunable coupler 140) which implements a tunable coupling mode (or tunable mode), and a second coupler 150 (or fixed coupler 150) which implements a fixed coupling mode (or fixed mode). The first coupler 140 is capacitively coupled to differential modes of the first qubit 110, and capacitively coupled to differential modes of the second qubit 120. In addition, the second coupler 150 is capacitively coupled to differential modes of the first qubit 110, and capacitively coupled to differential modes of the second qubit 120.

As schematically shown in FIG. 1, the differential coupler 130 is configured to have equal coupler-qubit coupling with the first and second qubits 110 and 120, wherein a magnitude of the coupler-qubit coupling is denoted g. More specifically, in an exemplary embodiment, the first (tunable) coupler 140 is capacitively coupled to the first and second qubits 110 and 120 with a same magnitude and polarity of coupling, e.g., denoted −g. Moreover, the second (fixed) coupler 150 is capacitively coupled to the first and second qubits 110 and 120 with a same magnitude of coupler-qubit coupling, but with opposite polarity. For example, as schematically shown in FIG. 1, the second coupler 150 is capacitively coupled to the first qubit 110 with a coupling of −g, while the second coupler 150 is capacitively coupled to the second qubit 120 with a coupling of +g.

In the exemplary coupling configuration of FIG. 1, the coupler-qubit coupling between the tunable and fixed coupling modes of the differential coupler 130 and the first and second qubits 110 and 120 is configured to cancel a direct capacitive coupling (generally denoted J) between the first and second qubits 110 and 120. In particular, as schematically shown in FIG. 1, the differential coupler 130 is configured to provide (i) a first direct capacitive coupling of +J between the first and second qubits 110 and 120 through the first (tunable) coupler 140, and (ii) a second direct capacitive coupling of −J between the first and second qubits 110 and 120 through the second (fixed) coupler 150, wherein the first and second direct capacitive couplings +J and −J have a same magnitude, but oppositive polarity. In this regard, the differential coupler 130 is configured to eliminate or otherwise substantially suppress the direct capacitive coupling J between the first and second qubits 110 and 120 through the first and second modes of the differential coupler 130 which, as explained in further detail below, eliminates or otherwise substantially suppresses spurious coupling to next nearest neighbor (NNN) qubits.

The differential coupler 130 is configured to eliminate or otherwise substantially suppress the direct capacitive coupling J between the first and second qubits 110 and 120 irrespective of the operating state of the differential coupler 130. In particular, the differential coupling of the first and second qubits 110 and 120 to each of the tunable and fixed coupler modes of the differential coupler 130 is configured to provide the first and second direct capacitive couplings +J and −J with the same magnitude and opposite polarity for all operating modes of the differential coupler 130 (thereby eliminating or substantially suppressing the direct capacitive coupling J between the first and second qubits 110 and 120), while allowing the differential coupler 130 to be tuned (e.g., flux tuned) into different operating states (e.g., ON state, OFF state) by tuning the first (tunable) coupler 140 to modulate the coupling between the first and second qubits 110 and 120 and, thus mediate the interaction between the first and second qubits 110 and 120.

More specifically, the differential coupler 130 is configured to eliminate or otherwise substantially suppress the direct capacitive coupling J between the first and second qubits 110 and 120, wherein such cancellation does not depend on the operating state of the differential coupler 130 or the transition frequencies of the first and second qubits 110 and 120. The coupling between the first and second qubits 110 and 120 is controlled by tuning a resonant frequency of the first (tunable) coupler 140 to adjust a relative detuning between the first (tunable) coupler 140 and the second (fixed) coupler 150 to thereby adjust a total net coupler-qubit coupling g through the tunable and fixed modes of the differential coupler 130 to modulate a total effective coupling between the first and second qubits 110 and 120.

For example, in some embodiments, when first coupler 140 and the second coupler 150 have corresponding resonant frequencies (e.g., the resonant frequencies of the first coupler 140 and the second coupler 150 are the same or substantially the same), this results in cancelling the effective coupler-qubit couplings g through the tunable and fixed modes of the differential coupler 130, thereby resulting in a zero (0) total effective coupling between the first and second qubits 110 and 120. On the other hand, when the resonant frequency of the first (tunable) coupler 140 is detuned from the resonant frequency of the second (fixed) coupler 150, this results in increasing effective coupler-qubit couplings g through the tunable and fixed modes of the differential coupler 130, thereby resulting in a non-zero total effective coupling between the first and second qubits 110 and 120.

In this regard, the differential coupler 130 can be placed in a first operating state (e.g., OFF state) by tuning the resonant frequency of the first (tunable) coupler 140 to be the same or substantially the same as the resonant frequency of the second (fixed) coupler 150. In the OFF state, there is a net-zero direct capacitive coupling (e.g., +J≅−J) between the first and second qubits 110 and 120, as well as net-zero coupler-qubit couplings g through the tunable and fixed modes of the differential coupler 130. Therefore, placing in the differential coupler 130 in the OFF state results in a net-zero (0) total effective coupling between the first and second qubits 110 and 120. On the other hand, the differential coupler 130 can be placed in second operating state (e.g., ON state) by tuning the resonant frequency of the first (tunable) coupler 140 to be different from the resonant frequency of the second (fixed) coupler 150. In the ON state, there is a net-zero direct capacitive coupling (e.g., +J≅−J) between the first and second qubits 110 and 120. However, in the ON state, the detuning between the first coupler 140 and the second coupler 150 results in an effective coupler-qubit coupling through the tunable and fixed modes of the differential coupler 130, thereby resulting in a non-zero total effective coupling between the first and second qubits 110 and 120.

In some embodiments, the second (fixed) coupler 150 is configured to have a fixed coupler frequency (denoted f_{C_fixed}) that is well detuned from the transition frequency (denoted f_{Q1}) of the first qubit 110 and the transition frequency (denoted f_{Q2}) of the second qubit 120. For example, f_{C_fixed}<<f_{Q1} and f_{C_fixed}<<f_{Q2}. In an exemplary embodiment, the respective transition frequencies f_{Q1} and f_{Q2} of the first and second qubits 110 and 120 are detuned by a given amount Δ₁₂=f_{Q2}−f_{Q1}, where f_{Q2}>f_{Q1}, for purposes of, e.g., avoiding frequency collisions between the first and second qubits 110 and 120. The fixed coupler frequency (f_{C_fixed}) of the second coupler 150 essentially corresponds to an OFF-state frequency of the differential coupler 130.

When the resonant frequency of the first (tunable) coupler 140 is tuned to be degenerate with the fixed coupler frequency f_{C_fixed} of the second (fixed) coupler 150, this results in substantially zero coupling between the first and second qubits 110 and 120. On the other hand, when the resonant frequency of the first (tunable) coupler 140 is tuned away from the fixed coupler frequency f_{C_fixed} of the second coupler 150 and towards the transition frequency the first qubit 110 or the second qubit 120, this results in increasing the coupling between the first and second qubits 110 and 120 through differential coupler 130. In this regard, a particularly high qubit-qubit coupling can be achieved by tuning the resonant frequency of the first (tunable) coupler 140 to be nearly degenerate with one of the first and second qubits 110 and 120 (e.g., transition frequency f_{Q1} of the first qubit 110), well away from the resonant frequency of the second (fixed) coupler 150.

As further schematically illustrated in FIG. 1, the superconducting quantum circuit 100 comprises a plurality of control lines including, but not limited to, qubit drive lines 111 and 121, and a coupler drive line 131 (e.g., flux bias control line), and qubit readout lines 112 and 122 (e.g., readout resonators). In some embodiments, the qubit drive lines 111 and 121 are coupled (e.g., capacitively coupled via capacitors) to the first and second qubits 110 and 120, respectively. In some embodiments, the qubit drive lines 111 and 121 are configured to apply control signals (e.g., microwave pulse signals) to independently change the states of the respective first and second qubits 110 and 120 (e.g., single-qubit gate operations). In particular, the qubit drive lines 111 and 121 are utilized to, e.g., apply microwave control signals to drive single-qubit X-rotation gates and single-qubit Y-rotation gates, and perform other functions as discussed herein. As is known in the art, the state of a qubit can be changed by applying a microwave control signal (e.g., control pulse) with a center frequency equal to a transition frequency (generally denoted f₀₁) of the qubit, wherein the transition frequency f₀₁ corresponds to an energy difference between the ground state |0 [symbol] and excited state |1 [symbol] of the qubit. In addition, the axis of rotation about a given axis of the Bloch sphere (e.g., X-axis and/or Y-axis) and the amount (angle) of such rotation are based, respectively, on the phase of the microwave control signal and the amplitude and duration of the microwave control signal.

The coupler drive line 131 is coupled to the first (tunable) coupler 140 of the differential coupler 130 and is configured to apply a control signal to tune the frequency of the first (tunable) coupler 140. The coupler drive line 131 can be capacitively coupled or mutually coupled to the first (tunable) coupler 140, depending on the circuit configuration of the first (tunable) coupler 140. For example, in an exemplary embodiment, the first (tunable) coupler 140 comprises a flux tunable element, e.g., a DC SQUID, which can be flux-tuned to adjust a resonant frequency of the first (tunable) coupler 140 and, thereby, modulate the coupling between the first and second qubits 110 and 120. For example, when the frequency of the first coupler 140 is tuned to place the differential coupler 130 in in an OFF state, this results in cancelling or substantially suppressing the coupling between the first and second qubits 110 and 120, whereby the quantum state of one qubit will not affect the transition frequency of the other qubit. In this regard, when the tunable differential coupler 130 is in the OFF state, the first and second qubits 110 and 120 are essentially decoupled with substantially no quantum cross-talk between first and second qubits 110 and 120. This allows single-qubit gate operations to be independently performed on the first and second qubits 110 and 120 without the inducement of coherent errors during such single-qubit gate operations that may otherwise result from either longitudinal or transverse interactions between the first and second qubits 110 and 120.

On the other hand, when the frequency of the first coupler 140 is tuned to place the differential coupler 130 in an ON state, the differential coupler 130 enables a controlled amount of coupling between the first and second qubits 110 and 120 to enable an interaction (e.g., entanglement) between the states of the first and second qubits 110 and 120. In this manner, the tunable differential coupler 130 is configured to facilitate two-qubit entanglement gates including, but not limited to longitudinal two-qubit gates (e.g., a controlled-phase gate (referred to as CPHASE gate or CZ gate)) and transversal two-qubit gates (e.g., SWAP or iSWAP gates). For example, a CPHASE gate between two qubits is a type of entangling gate in which one qubit (e.g., target qubit) acquires a phase-shift if and only if both qubits are in their first excited state.

Further, in some embodiments, the qubit readout lines 112 and 122 are coupled to the first and second qubits 110 and 120, respectively, using known techniques. In some embodiments, the qubit readout lines 112 and 122 comprise transmission line readout resonators (e.g., coplanar waveguide resonators) which are configured to have resonant frequencies that are detuned from the respective transition frequencies of the respective first and second qubits 110 and 120. In some embodiments, the first and second qubits 110 and 120 are dispersively coupled to the qubit readout lines 112 and 122 for their state readout. In some embodiments, a dispersive readout operation for reading the quantum state of a given superconducting qubit which is coupled to a given readout resonator, is performed by applying an RF readout control signal to the given readout resonator, and detecting/processing the readout signal that is reflected out from the given readout resonator. An RF readout control signal that is applied to the given readout resonator has a single frequency tone that is the same or similar to the resonant frequency of the readout resonator, a pulse envelope with a given pulse shape (e.g., gaussian pulse envelope), and given pulse duration. In the dispersive regime of qubit-resonator coupling, the RF readout control signal interacts with the given qubit/resonator system, and the resulting output readout signal which is reflected out from the given readout resonator comprises information (e.g., phase and/or amplitude) that is qubit-state dependent.

It is to be noted that for ease of illustration and explanation, FIG. 1 and other exemplary embodiments are discussed in the context of an exemplary quantum circuit comprising two superconducting qubits that are coupled to a single tunable coupler. It is to be understood, however, that a quantum processor can have any number of superconducting qubits arranged in a given qubit lattice (e.g., a heavy hexagonal qubit lattice, a square qubit lattice, etc.) with a tunable coupler architecture in which a given tunable coupler can be coupled to more than two superconducting qubits in the given qubit lattice. In this regard, the exemplary differential coupler techniques as discussed herein are widely applicable in various quantum processor architectures.

Furthermore, while the first and second qubits 110 and 120 are generically illustrated in FIG. 1, it is to be understood that the first and second qubits 110 and 120 can be implemented using any type of superconducting qubit architecture. For example, the first and second qubits 110 and 120 can be implemented using superconducting transmon qubits, fluxonium qubits, multimode qubits (e.g., two-junction qubits, or tunable coupling qubits), and other suitable types of superconducting qubits. The first and second qubits 110 and 120 can be fixed-frequency qubits, or tunable frequency qubits. Moreover, in some embodiments, the first (tunable) coupler 140 is implemented using a frequency-tunable qubit, and the second (fixed) coupler 150 is implemented using a fixed-frequency qubit.

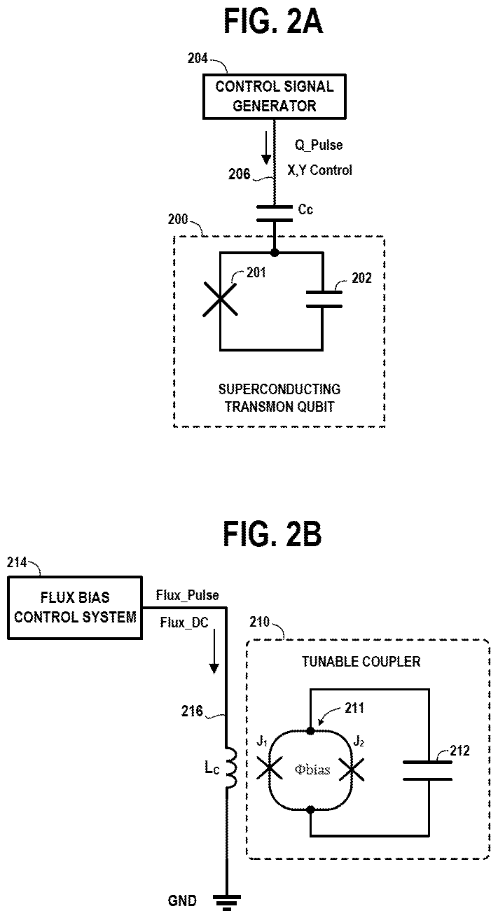

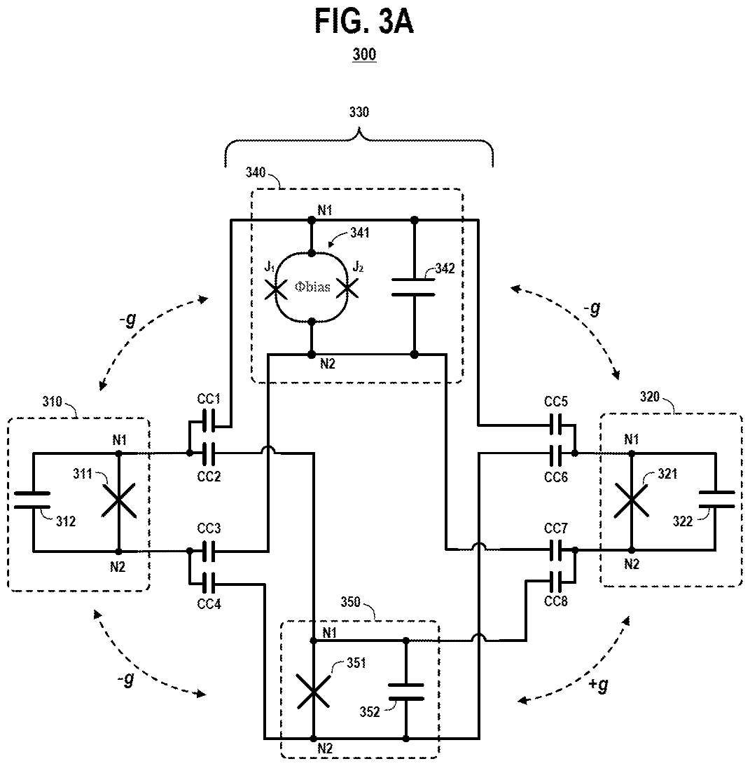

For example, FIG. 2A schematically illustrates an exemplary superconducting qubit which can be implemented in the superconducting quantum circuit of FIG. 1, according to an exemplary embodiment of the disclosure. In particular, FIG. 2A schematically illustrates a superconducting qubit 200 which comprises a fixed-frequency transmon qubit that comprises a superconducting Josephson junction 201 connected in parallel with a capacitor 202. The Josephson junction 201 functions as a non-linear inductor which, when shunted with the capacitor 202, forms an anharmonic LC oscillator with individually addressable energy levels (e.g., two lowest energy levels corresponding to computational basis states including the ground state |0 [symbol] and the first excited state |1 [symbol] ). In some embodiments, the first and second qubits 110 and 120 in FIG. 1 are each implemented using a fixed-frequency superconducting transmon qubit such as shown in FIG. 2A, while in other embodiments, as noted above, the first and second qubits 110 and 120 in FIG. 1 can be other types of superconducting qubits such as, e.g., fluxonium qubits, multimode qubits, and other types of fixed-frequency qubits, or tunable-frequency qubits.

As further shown in FIG. 2A, a control signal generator 204 is configured to generate a given microwave pulse (denoted Q_Pulse) to drive single qubit X- and Y-rotation gates on the superconducting qubit 200. The microwave pulse, Q_Pulse, is applied to a qubit drive line 206 which is capacitively coupled to the superconducting qubit 200 via a coupling capacitor Cc. In some embodiments, the control signal generator 204 comprises a multi-channel arbitrary waveform generator (AWG) which is configured to generate control signals to control the operation (e.g., state change and readout) of superconducting qubit 200. To implement an X gate and/or Y gates, a suitable microwave control pulse Q_Pulse is generated which has a center frequency (tone) near or equal to the transition frequency of the superconducting qubit 200, and suitably shaped pulse envelope (e.g., a gaussian pulse envelope), that is calibrated to drive f₀₁ transitions of the superconducting qubit 200, while suppressing f₁₂ and higher transitions. The microwave control pulse Q_Pulse is configured to change the state of the superconducting qubit 200 by rotating the state of the given qubit about an axis in the Bloch sphere, wherein such rotations include X-axis rotations, Y-axis rotations, and/or rotations about any axis in the X-Y plane of the Bloch sphere, wherein the axis of rotation about a given axis of the Bloch sphere and the amount (angle) of such rotation are based, respectively, on the phase of the microwave control signal, and the amplitude and duration of the microwave control signal.

In addition, the control signal generator 204 is configured to generate a readout control signal which comprises an RF control pulse with a center frequency that corresponds to the resonant frequency of a readout resonator that is coupled to the superconducting qubit 200. As noted above, a readout resonator that is coupled to a given qubit comprises, e.g., half-wavelength coplanar waveguide resonator, which is utilized to readout the quantum state of the given qubit using, e.g., dispersive readout systems and techniques, which are well-known to those of ordinary skill in the art. For ease of illustration, FIG. 2A does not illustrate the readout resonator or readout signal chains which transmit the readout signal to readout processing circuitry.

Next, FIG. 2B schematically illustrates an exemplary tunable coupler which can be implemented for the tunable mode of the differential coupler 130 of the superconducting quantum circuit of FIG. 1, according to an exemplary embodiment of the disclosure. In particular, FIG. 2B schematically illustrates a tunable qubit coupler 210 which comprises a flux-tunable transmon qubit coupler having a flux-tunable operating frequency (e.g., resonant frequency). The tunable qubit coupler 210 is similar in structure to the superconducting qubit 200 of FIG. 2A, except that the tunable qubit coupler 210 is configured to be flux-tunable by implementing a DC SQUID 211 in place of the single Josephson junction 201, wherein the DC SQUID 211 is coupled in parallel with a capacitor 212. The DC SQUID 211 comprises a first Josephson junction J1 and a second Josephson junction J2, which are connected in parallel to form a superconducting loop (referred to as SQUID loop) through which an external magnetic flux bias Φ_{Bias} is threaded to adjust the frequency of the tunable qubit coupler 210 and thus change the operating state of the differential coupler 130.

As further schematically shown in FIG. 2B, a flux bias control system 214 is configured to generate flux bias control signals, denoted Flux_DC and Flux_Pulse, to tune the operating frequency of the tunable qubit coupler 210. The flux bias control signals Flux_DC and Flux_Pulse are applied to a coupler drive line 216, and magnetically coupled to the DC SQUID 211 via a coupling inductor Lc. The Flux_DC control signal comprises a DC flux bias signal that is magnetically coupled to the DC SQUID 211 to generate a static magnetic field that threads through the superconducting loop of the DC SQUID 211. The static magnetic field modulates the critical current, and thus, the Josephson energy of the DC SQUID 211 in a manner which causes the tunable qubit coupler 210 to be maintained at first operating frequency which, in the exemplary embodiment of FIG. 1, corresponds to an OFF-state frequency of the differential coupler 130, e.g., the first operating frequency of the tunable qubit coupler 210 is degenerate with the fixed frequency (f_{C_fixed}) of the second (fixed) coupler 150.

On the other hand, a flux bias control signal Flux_Pulse can be generated to temporarily tune the operating frequency of the tunable qubit coupler 210 to a second operating frequency which, in the exemplary embodiment of FIG. 1, corresponds to an ON-state frequency of the differential coupler 130, e.g., the second operating frequency of the tunable qubit coupler 210 is detuned from the fixed frequency (f_{C_fixed}) of the second (fixed) coupler 150. The flux bias control signal Flux_Pulse is applied, when needed, to increase the coupling between the first and second qubits 110 and 120 and thus modulate an interaction between the first and second qubits 110 and 120. In this instance, the flux bias control signal (Flux_Pulse) is combined with the DC flux bias signal (Flux_DC) to dynamically increase the flux bias current through the coupling inductor Lc and thereby change the magnetic of the flux bias Φ_{Bias} that is threaded through the superconducting loop of the DC SQUID 211 for purposes of, e.g., increasing the operating frequency of the tunable qubit coupler 210 to towards the transition frequency of the first qubit 110 or the second qubit 120 for a duration of the flux bias control signal (Flux_Pulse) to facilitate a coupler-mediated entanglement gate between the first and second qubits 110 and 120.

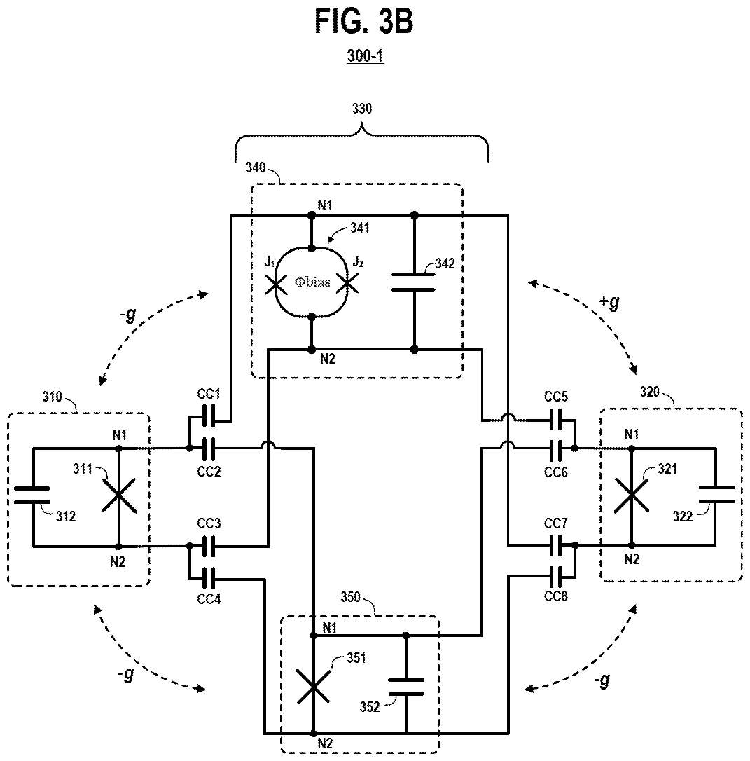

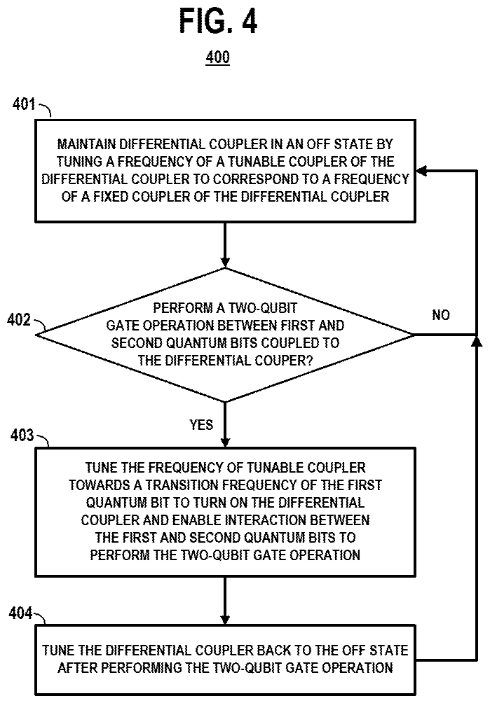

FIG. 3A schematically illustrates a superconducting quantum circuit comprising a tunable differential coupler that is configured to modulate a coupling between superconducting quantum bits, according to another exemplary embodiment of the disclosure. In particular, FIG. 3A schematically illustrates a superconducting quantum circuit 300 comprising a first superconducting quantum bit 310 (or first qubit 310), a second superconducting quantum bit 320 (or second qubit 320), and a tunable differential coupler 330 (or differential coupler 330). In the exemplary embodiment of FIG. 3A, the first qubit 310 and the second qubit 320 each comprise a superconducting transmon qubit that is similar to the exemplary transmon qubit architecture as discussed above in conjunction with FIG. 2A. In particular, as schematically shown in FIG. 3A, the first qubit 310 comprises a superconducting Josephson junction 311 connected in parallel with a capacitor 312 between a first node N1 and a second node N2 (differential nodes) of the first qubit 310. The first and second nodes N1 and N2 of the first qubit 310 correspond to differential modes of the first qubit 310. Similarly, the second qubit 320 comprises a superconducting Josephson junction 321 connected in parallel with a capacitor 322 between a first node N1 and a second node N2 (differential nodes) of the second qubit 320. The first and second nodes N1 and N2 of the second qubit 320 correspond to differential modes of the second qubit 320.

The differential coupler 330 comprises a tunable coupler 340 and a fixed coupler 350. In the exemplary embodiment of FIG. 3A, the tunable coupler 340 comprises a tunable transmon qubit coupler that is similar to the exemplary tunable transmon qubit coupler architecture as discussed above in conjunction with FIG. 2B. In particular, the tunable coupler 340 comprises a DC SQUID 341 and a capacitor 342, which are connected in parallel between a first node N1 and a second node N2 (differential nodes) of the tunable coupler 340, wherein the first and second nodes N1 and N2 of the tunable coupler 340 correspond to differential modes of the tunable coupler 340. The DC SQUID 341 comprises a first Josephson junction J1 and a second Josephson junction J2, which are connected in parallel between the first and second nodes N1 and N2 to form a superconducting SQUID loop through which an external magnetic flux bias Φ_{Bias} is threaded to adjust the frequency of the tunable coupler 340 and thus change the operating state of the differential coupler 330.

Furthermore, in the exemplary embodiment of FIG. 3A, the fixed coupler 350 comprises a fixed-frequency transmon qubit coupler which is similar to the exemplary transmon qubit architecture as discussed above in conjunction with FIG. 2A. In particular, the fixed coupler 350 comprises a superconducting Josephson junction 351 connected in parallel with a capacitor 352 between a first node N1 and a second node N2 (differential nodes) of the fixed coupler 350, wherein the first and second nodes N1 and N2 of the fixed coupler 350 correspond to differential modes of the fixed coupler 350.

The differential coupler 330 implements a tunable coupler mode (via the tunable coupler 340) and a fixed coupler mode (via the fixed coupler 350) to control the coupling between the first and second qubits 310 and 320 and thus control the interaction between the first and second qubits 310 and 320 to perform gate operations, in the same or similar manner as discussed above in conjunction with the exemplary differential coupler 130 of FIG. 1. In the exemplary embodiment of FIG. 3A, the tunable coupler 340 and the fixed coupler 350 are coupled to the differential modes of both the first and second qubits 310 and 320 and have equal (or substantially equal) coupling to the two modes. However, the tunable coupler 340 (tunable mode) is capacitively coupled to both the first and second qubits 310 and 320 such that polarities between the tunable coupler 340 and the first and second qubits 310 and 320 are the same, while the fixed coupler 350 (fixed mode) is capacitively coupled to both the first and second qubits 310 and 320 such that polarities between the fixed coupler 350 and the first and second qubits 310 and 320 are inverted.

In particular, as schematically shown in FIG. 3A, the first (positive) node N1 of the first qubit 310 is (i) capacitively coupled to the first (positive) node N1 of the tunable coupler 340 via a coupling capacitance CC1, and (ii) capacitively coupled to the first (positive) node N1 of the fixed coupler 350 via a coupling capacitance CC2. The second (negative) node N2 of the first qubit 310 is (i) capacitively coupled to the second (negative) node N2 of the tunable coupler 340 via a coupling capacitance CC3, and (ii) capacitively coupled to the second (negative) node N2 of the fixed coupler 350 via a coupling capacitance CC4.

Further, the first (positive) node N1 of the second qubit 320 is (i) capacitively coupled to the first (positive) node N1 of the tunable coupler 340 via a coupling capacitance CC5, and (ii) capacitively coupled to the second (negative) node N2 of the fixed coupler 350 via a coupling capacitance CC6. The second (negative) node N2 of the second qubit 320 is (i) capacitively coupled to the second (negative) node N2 of the tunable coupler 340 via a coupling capacitance CC7, and (ii) capacitively coupled to the first (positive) node N1 of the fixed coupler 350 via a coupling capacitance CC8.

In an exemplary embodiment, the coupling capacitances CC1-CC8 are substantially the same to achieve substantially equal coupler-qubit couplings between the tunable and fixed coupler modes, and each of the first and second qubits 310 and 320 to thereby obtain equal and opposite direct capacitive couplings (e.g., +J equal to, or substantially equal to, −J) and effectively cancel or substantially suppress the direct capacitive couplings +J and −J between the first and second qubits 310 and 320 through the tunable coupler 340 (tunable coupling mode) and the fixed coupler 350 (fixed coupling mode), as discussed above.

More specifically, in the exemplary configuration shown in FIG. 3A, the first qubit 310 sees a positive differential capacitance through the tunable coupler 340, and the second qubit 320 sees a positive differential capacitance through the tunable coupler 340, which provides the direct capacitive coupling +J between the first and second qubits 310 and 320. On the other hand, the first qubit 310 sees a positive differential capacitance through the fixed coupler 350, while the second qubit 320 sees a negative differential capacitance through the fixed coupler 350, which provides the opposite polarity of the direct capacitive coupling −J between the first and second qubits 310 and 320. When the capacitive couplings are the same (e.g., CC1=CC2=CC3=CC4=CC5=CC6=CC7=CC8), the direct capacitive couplings +J and −J have equal magnitude, and opposite polarities, which result in cancellation of the direct capacitive coupling between the first and second qubits 310 and 320 through the differential coupler 330.

FIG. 3B schematically illustrates a superconducting quantum circuit comprising a tunable differential coupler that is configured to modulate a coupling between superconducting quantum bits, according to another exemplary embodiment of the disclosure. In particular, FIG. 3B schematically illustrates a superconducting quantum circuit 300-1 which is similar to the superconducting quantum circuit 300 of FIG. 3A, in that the tunable coupler 340 and the fixed coupler 350 are coupled to the differential modes of both the first and second qubits 310 and 320 and have equal (or substantially equal) coupling to the two modes. However, FIG. 3B illustrates an alternative embodiment of FIG. 3A in which the fixed coupler 350 (fixed mode) is capacitively coupled to both the first and second qubits 310 and 320 such that polarities between the fixed coupler 350 and the first and second qubits 310 and 320 are the same, while the tunable coupler 340 (tunable mode) is capacitively coupled to both the first and second qubits 310 and 320 such that polarities between the tunable coupler 340 and the first and second qubits 310 and 320 are inverted.

In particular, as schematically shown in FIG. 3B, similar to the embodiment of FIG. 3A, the first (positive) node N1 of the first qubit 310 is (i) capacitively coupled to the first (positive) node N1 of the tunable coupler 340 via a coupling capacitance CC1, and (ii) capacitively coupled to the first (positive) node N1 of the fixed coupler 350 via a coupling capacitance CC2. The second (negative) node N2 of the first qubit 310 is (i) capacitively coupled to the second (negative) node N2 of the tunable coupler 340 via a coupling capacitance CC3, and (ii) capacitively coupled to the second (negative) node N2 of the fixed coupler 350 via a coupling capacitance CC4.

Further, in contrast to the embodiment of FIG. 3A, as schematically illustrated in FIG. 3B, the first (positive) node N1 of the second qubit 320 is (i) capacitively coupled to the second (negative) node N2 of the tunable coupler 340 via a coupling capacitance CC5, and (ii) capacitively coupled to the first (positive) node N1 of the fixed coupler 350 via a coupling capacitance CC6. The second (negative) node N2 of the second qubit 320 is (i) capacitively coupled to the first (positive) node N1 of the tunable coupler 340 via a coupling capacitance CC7, and (ii) capacitively coupled to the second (negative) node N2 of the fixed coupler 350 via a coupling capacitance CC8.

In summary, FIGS. 3A and 3B schematically illustrate exemplary embodiments of a superconducting quantum circuit comprising a coupler, a first quantum bit, and a second quantum bit, wherein the coupler comprises a tunable coupler and a fixed coupler. The tunable coupler is differentially coupled to the first quantum bit and differentially coupled to the second quantum bit. The fixed coupler is differentially coupled to the first quantum bit and differentially coupled to second quantum bit. In FIGS. 3A and 3B only one of the tunable coupler and the fixed coupler is differentially coupled to the first quantum bit and the second quantum bit with opposite polarities, while the other of the tunable coupler and the fixed coupler is differentially coupled to the first quantum bit and the second quantum bit with the same polarity. In particular, FIG. 3A illustrates an exemplary embodiment where the fixed coupler 350 is differentially coupled to the first quantum bit 310 and the second quantum bit 320 with opposite polarities, while the tunable coupler 340 is differentially coupled to the first quantum bit 310 and the second quantum bit 320 with the same polarity. Moreover, FIG. 3B illustrates an exemplary embodiment where the tunable coupler 340 is differentially coupled to the first quantum bit 310 and the second quantum bit 320 with opposite polarities, while the fixed coupler 350 is differentially coupled to the first quantum bit 310 and the second quantum bit 320 with the same polarity.

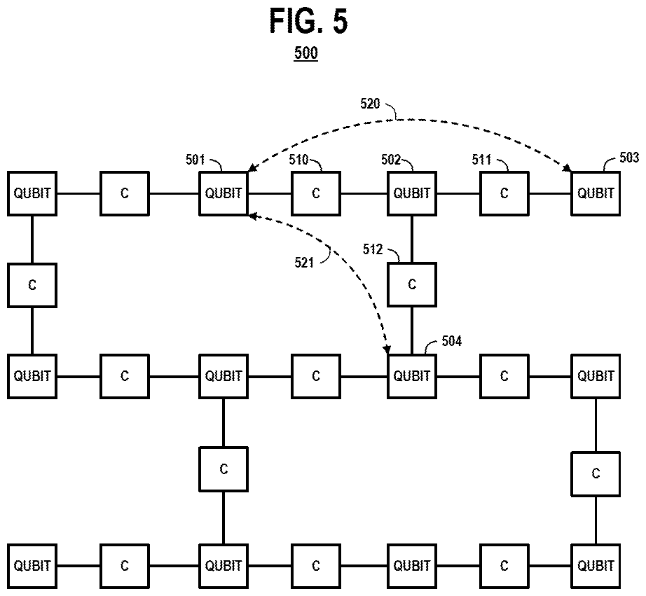

FIG. 4 is a flow diagram of a method for utilizing a differential coupler to modulate a coupling between superconducting qubits, according to an exemplary embodiment of the disclosure. In particular, FIG. 4 illustrates a method 400 for utilizing a differential coupler comprising a tunable coupling mode and a fixed coupling mode to modulate a coupling between first and second superconducting qubits that are differentially coupled to the tunable and fixed coupling modes, according to an exemplary embodiment of the disclosure. In some embodiments, the method 400 of FIG. 4 illustrates exemplary modes operation of the exemplary differential couplers of FIGS. 1 and 3. For illustrative purposes, the method will be discussed in the context of the exemplary quantum circuit of FIG. 1 in which the tunable differential coupler 130 is configured to modulate the coupling between the first and second qubits 110 and 120. superconducting qubits.

The differential coupler 130 is placed and maintained in an OFF state by tuning the frequency of the tunable coupler 140 to correspond to the frequency of the fixed coupler 150 (block 401). For example, in an exemplary embodiment where the tunable coupler 140 comprises a flux-tunable qubit coupler, and the fixed coupler 150 comprises a fixed-frequency qubit coupler, the fixed coupler 150 will have a transition frequency that is well-detuned from the transition frequencies of the first and second qubits 110 and 120, and the differential coupler is maintained in an OFF state by flux-tuning the tunable coupler 140 to have a transition frequency that corresponds to (e.g., the same as or substantially the same as) with the transition frequency of the fixed coupler 150.

As noted above, the differential coupler 130 is configured such that in all operating states of the differential coupler 130, the direct capacitive coupling between the first and second qubits 110 and 120 through the tunable coupler 140 and the fixed coupler 150 are equal and opposite (e.g., +J≅−J) which essentially results in a net-zero direct capacitive coupling between the first and second qubits 110 and 120. Moreover, in the OFF state of the differential coupler 130, the coupler-qubit couplings g between the tunable coupler 140 and the first and second qubits 110 and 120 essentially cancel the coupler-qubit couplings g between the fixed coupler 150 and the first and second qubits 110 and 120, which essentially results in a net-zero coupler-qubit couplings g through the tunable and fixed coupling modes of the differential coupler 130. Consequently, in the OFF state of the differential coupler 130, the coupling strength between the first and second qubits 110 and 120 is substantially zero (0).

When no two-qubit gate operation is to be performed between the first and second qubits 110 and 120 (negative determination in block 402), the differential coupler 130 will be maintained in the OFF state to prevent coupling between the first and second qubits 110 and 120. In the OFF state of the differential coupler 130, the quantum states of the first and second qubits 110 and 120 can be manipulated independently by performing single-qubit gate operations on the first qubit 110 and/or second qubit 120, without perturbing the quantum states of the first and second qubits 110 and 120 due to, e.g. residual/static longitudinal coupling (e.g., ZZ coupling) through the differential coupler 130.

When a two-qubit gate operation is to be performed between the first and second qubits 110 and 120 (affirmative determination in block 402), the differential coupler 130 is placed into an ON state by tuning the frequency of the tunable coupler 140 towards a transition frequency of, e.g., the first qubit 110 to increase a coupling between the first and second qubits 110 and 120 and to enable/modulate an interaction between the first and second qubits 110 and 120 to perform the two-qubit gate operation (block 403). For example, in some embodiments where the tunable coupler 140 comprises a flux-tunable qubit coupler, a flux control signal will be applied to a tunable element (e.g., DC SQUID) of the tunable coupler 140 to increase a transition frequency of the tunable coupled 140 to be closer (e.g., nearly degenerate) with the transition frequency of, e.g., the first qubit 110, and place the differential coupler in the ON state to increase the coupling and enable interaction between the first and second qubits 110 and 120.

In the ON state of the differential coupler 130, the coupler-qubit couplings g between the tunable coupler 140 and the first and second qubits 110 and 120 increases to level that is greater than the coupler-qubit couplings g between the fixed coupler 150 and the first and second qubits 110 and 120, which essentially results in an overall net coupler-qubit couplings g through the tunable and fixed coupling modes of the differential coupler 130. Consequently, in the ON state of the differential coupler 130, the coupling strength between the first and second qubits 110 and 120 is increased to mediate the interaction between the first and second qubits 110 and 120 to perform the two-qubit gate operation. As noted above, in the ON state of the differential coupler 130, the direct capacitive coupling between the first and second qubits 110 and 120 through the tunable coupler 140 and the fixed coupler 150 remains equal and opposite (e.g., +J≅−J) which essentially results in a net-zero direct capacitive coupling between the first and second qubits 110 and 120 in the ON state of the differential coupler 130.

After performing the two-qubit gate operation, the differential coupler 130 is placed back into the OFF state by tuning the frequency of the tunable coupler 140 to be degenerate with the frequency of the fixed coupler 150 (block 404). As noted above, the OFF state of the differential coupler 130 prevents coupling between the first and second qubits 110 and 120 and thus, prevents perturbance of the resulting entangled state of the first and second qubit 110 and 120 through residual/static longitudinal coupling (e.g., ZZ coupling) between the first and second qubits 110 and 120 through the differential coupler 130.

It is to be appreciated that the exemplary differential couplers and qubit-qubit coupling techniques described herein provide significant advantages over qubit coupling architectures which utilize a single tunable coupler to modulate the coupling between two data qubits. For example, existing coupling techniques utilize a single tunable coupler that is tuned to modulate the coupling between a first and second data qubit by adjusting the effective capacitive coupler-qubit coupling g between the tunable coupler and the data qubits to either (i) turn OFF the coupling by tuning the frequency of the tunable coupler to adjust the coupler-qubit coupling g to cancel a fixed direct coupling +J between the two data qubits, or (ii) turn ON the coupling by tuning the frequency of the tunable coupler to adjust the coupler-qubit coupling g to increase the coupling strength and mediate an interaction between the two data qubits.

A fundamental problem with coupling techniques that utilize a single tunable coupler mediate coupling between first and second data qubits, in conjunction with one fixed direct coupling +J between the first and second data qubits, is that such coupling techniques rely on a strategy of canceling a capacitive coupling (e.g., direct capacitive coupling +J) between two data qubits, with a resonant coupling (via a tunable coupler) between the two data qubits, which has significant disadvantages. For example, such a strategy of canceling a capacitive coupling with a resonant coupling makes the OFF state of the coupler narrowband, i.e., the OFF state strongly depends on a detuning between the two data qubits. Moreover, such coupling techniques introduce a network capacitance that cannot be canceled even when the tunable coupler is tuned in an OFF state, which results in the coupling of data qubits which are not supposed to be coupled when the tunable coupler is OFF.

In this regard, another fundamental problem associated with coupling techniques that utilize a single tunable coupler mediate coupling between first and second data qubits, in conjunction with one fixed direct coupling +J between the first and second data qubits, is that the direct capacitive coupling +J between first and second data qubits can result in stray coupling to another qubit (e.g., a third qubit, or spectator qubit) that is connected to either the first or second data qubit via another coupler. This stray coupling (e.g., next nearest neighbor (NNN) coupling) to spectator qubits results in “spectator” inducted errors in a qubit lattice. In a qubit lattice, it is highly desirable to control the coupling and interaction between two neighboring qubits (e.g., two qubits that are coupled by a coupler), while eliminating or substantially suppressing any stray coupling that results in NNN coupling (e.g., coupling to spectator qubits) which can result in spectator inducted errors in a qubit lattice.

The exemplary tunable differential couplers, architectures and techniques as disclosed herein are configured to eliminate stray coupling (e.g., NNN coupling) to spectator qubits and thus prevent unintended spectator coupling and associated spectator errors. Indeed, the exemplary tunable differential couplers as disclosed herein implement two separate resonant couplings (via a tunable coupler and a fixed coupler) to modulate the coupling between two data qubits, wherein the resonant frequencies of the tunable coupler and the fixed coupler can be made degenerate (i.e. the same or substantially the same) to cause the resonant coupling to interfere with each other and thereby completely cancel the coupling between the two data qubits. The differential capacitive coupling of the two data qubits to each of the tunable coupler and the fixed coupler, is configured to provide (i) a first direct capacitive coupling of +J between the two data qubits through, e.g., the tunable coupler, and (ii) a second direct capacitive coupling of −J between the two data qubits through, e.g., the fixed coupler. In this coupling scheme, the first and second direct capacitive couplings +J and −J have equal magnitudes and opposite polarities, which results in cancelling the direct capacitive coupling between the first and second data qubits, regardless of the operating state of the differential coupler and regardless of the detuning between the transition frequencies of the first and second data qubits.

In other words, the exemplary differential coupling scheme eliminates all direct capacitive couplings between the two data qubits so that the only effective coupling between the two data qubits comes from the two resonant modes (tunable coupler and fixed coupler) that couple the two data qubits. This allows the differential coupling scheme to provide wideband cancellation, wherein the cancellation is insensitive to the detuning between the two data qubits, and eliminates unwanted coupling to spectator data qubits. Advantageously, the cancellation of the direct capacitive coupling eliminates stray/spurious coupling (e.g., NNN coupling) to/from spectator qubits in a qubit lattice.

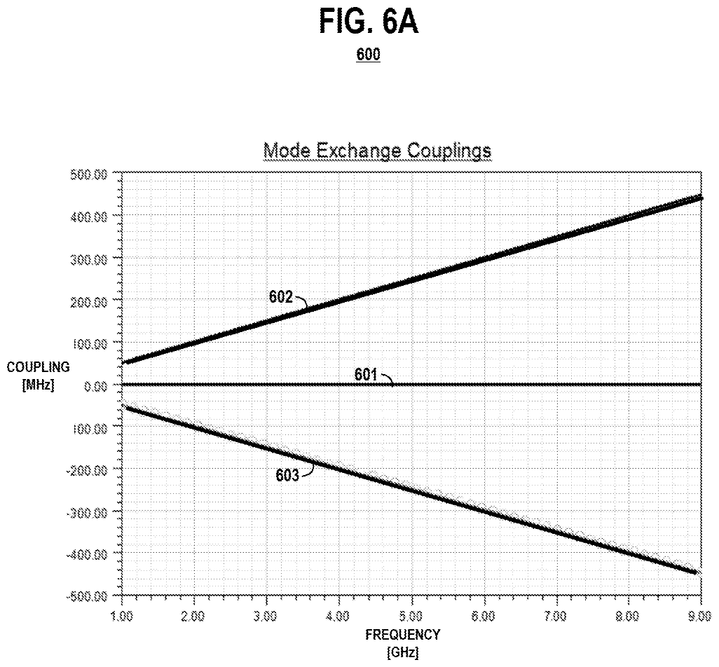

FIG. 5 schematically illustrates a qubit array comprising a plurality of qubits and tunable differential couplers that are configured to modulate couplings between qubits in the qubit array, according to exemplary embodiments of the disclosure. In particular, FIG. 5 schematically illustrates a qubit array 500 (or qubit lattice 500) which comprises a plurality of data qubits (labeled QUBIT) and tunable couplers (labeled C) to modulate the coupling between neighboring qubits. For example, FIG. 5 includes data qubits 501, 502, 503, and 504 (e.g., transmon qubits), and tunable differential couplers 510, 511, and 512 which are implemented using a tunable differential coupling architecture, e.g., tunable differential coupler 330, FIG. 3A, as described herein. In the exemplary embodiment of FIG. 5, the tunable differential coupler 510 is configured to modulate a coupling between the neighboring data qubits 501 and 502, the tunable differential coupler 511 is configured to modulate a coupling between the neighboring data qubits 502 and 503, the tunable differential coupler 512 is configured to modulate a coupling between the neighboring data qubits 502 and 504.

FIG. 5 schematically illustrates an undesirable circumstance in which the data qubit 503 and/or the data qubit 504 can be spectator qubits whose quantum states and/or transition frequencies are perturbed or otherwise adversely affected through respective stray couplings 520 and 521 with the data qubit 501, which can adversely affect the fidelity of an entanglement gate operations or otherwise lead to other spectator errors. The tunable differential couplers 510, 511, and 512, however, are configured to eliminate or otherwise significantly suppress any stray coupling or crosstalk between the data qubits 501, 503, and 504 when, e.g., the tunable differential coupler 510 is turned ON to couple the data qubits 501 and 502 and perform an entanglement gate operation. Indeed, as noted above, the tunable differential couplers (C) in the qubit array 500 allow enhanced coupling of direct qubit neighbors while eliminating stray coupling (e.g., NNN coupling) with spectator qubits. The exemplary tunable differential couplers (C) in the qubit array 500 allow an increase in the number of neighbors that each data qubit can have in the qubit array 500, while eliminating stray couplings that can lead to spectator induced errors.

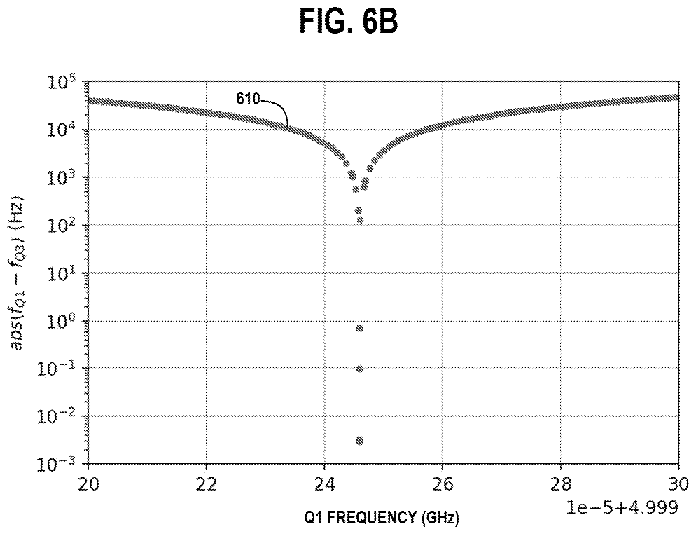

FIGS. 6A and 6B depict simulated waveforms which show exemplary operating characteristics of a tunable differential coupler, according to an exemplary embodiment of the disclosure. More specifically, FIGS. 6A and 6B depict simulated waveforms that show exemplary operating characteristics of a tunable differential coupler model based on the exemplary architecture of the tunable differential coupler 330 of FIG. 3A. FIG. 6A depicts a plurality of simulated waveforms 600 which represent coupling strength in MHz (Y-axis) of mode exchange couplings as a function of frequency in GHz (X-axis). In particular, in FIG. 6A, a first simulated waveform 601 represents a direct capacitive coupling between the first and second qubits 310 and 320. In this instance, the first simulated waveform 601 shows an effective net-zero direct capacitive coupling between the first and second qubits 310 and 320 which results from cancellation of the first and second direct capacitive couplings +J and −J of the first qubit 310 and the second qubit 320 through the tunable coupler 340 and the fixed coupler 350 of the differential coupler 330.

Further, in FIG. 6A, a second simulated waveform 602 represents the coupling strength of the mode exchange coupling from the fixed coupler 350 to the second qubit 320, as a function of frequency. In addition, a third simulated waveform 603 represents three simulated waveforms that are essentially the same, e.g., (i) the coupling strength of the mode exchange coupling from the fixed coupler 350 to the first qubit 310, (ii) the coupling strength of the mode exchange coupling from the tunable coupler 340 to the first qubit 310, and (iii) the coupling strength of the mode exchange coupling from the tunable coupler 340 to the second qubit 320. FIG. 6A illustrates that the second simulated waveform 602 is symmetric with the third simulated waveform 603 as a result of the differential coupling.

Next, FIG. 6B illustrates a simulated waveform 610 which represent an absolute value of a difference between a transition frequency f_{Q1} of the first qubit (Q1) and a transition frequency f_{Q3} of a third (spectator) qubit Q3 (Y-axis), as a function of the frequency of the first qubit Q1 in GHz (X-axis) over a relatively small range around 4.999 GHz. The simulated waveform 610 illustrates that an avoided level crossing between the first qubit Q1 and the third qubit Q3 is essentially zero, which indicates there is no spurious NNN coupling between the qubits Q1 and Q3.

For example, in the context of the exemplary qubit array 500 of FIG. 5, assuming that that Q1 corresponds to the data qubit 501 and that Q3 corresponds to the data qubit 503, the simulated waveform 610 of FIG. 6B illustrates that there is no spectator coupling between data qubits 501 and 502 (i.e., the stray coupling 520 is essentially zero). The simulated waveform 610 is generated as a result of a simulated process in which, e.g., the frequency of the qubit Q1 is swept to try and put Q1 into resonance with Q3. If there is any NNN coupling between Q1 and Q3, the frequency of Q3 will change as the frequency of Q1 approaches the frequency of Q3 such that the frequencies of Q1 and Q3 cannot be too close or otherwise placed into resonance. For example, assuming that Q1 and Q3 have some level of coupling (e.g., 100 MHz of coupling), the frequencies of Q1 and Q3 cannot get any closer than 100 MHz of each other. The simulated waveform 610 of FIG. 6B shows that the difference between the frequencies of Q1 and Q3 can be very close, e.g., less than 1 Hz of each other, which is an indication of no spectator coupling between Q1 and Q3.

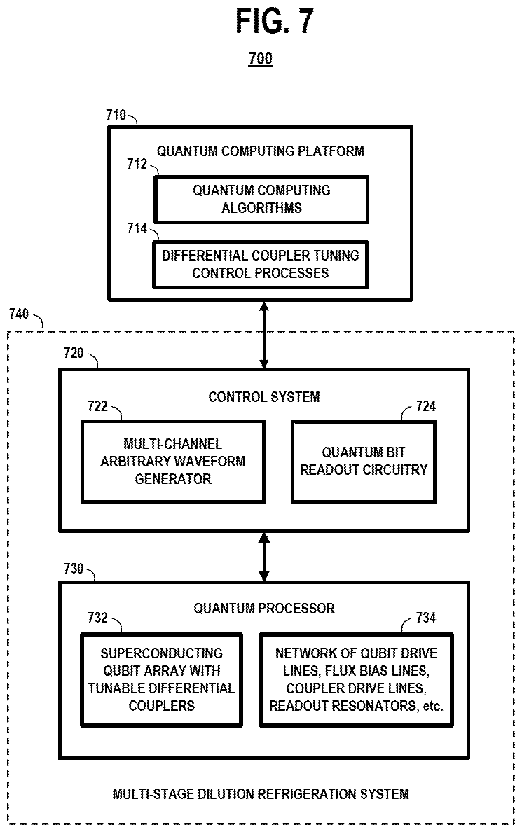

FIG. 7 schematically illustrates a quantum computing system 700 which comprises a quantum computing platform 710, a control system 720, and a quantum processor 730. The quantum processor 730 comprises one or more solid-state quantum chips which comprise, e.g., a superconducting qubit array with tunable differential couplers 732, and a network 734 of qubit drive lines, flux-bias control lines, coupler drive lines, qubit state readout resonators, and other circuit QED components that may be needed for a given application or quantum system configuration. In some embodiments, the quantum computing platform 710 implements a software platform that is configured to program a quantum computer to execute quantum computing algorithms 712 which are implemented using, e.g., quantum circuits which define computational routings consisting of coherent quantum operations on quantum data encoded by qubits. In addition, the quantum computing platform 710 is configured to implement differential coupler tuning control processes 714 to tune the differential couplers and thereby control/modulate the couplings between qubits in the qubit array.

In some embodiments, the control system 720 comprises a multi-channel arbitrary waveform generator 722, and quantum bit readout control circuitry 724. In some embodiments, the control system 720 and the quantum processor 730 are disposed in a dilution refrigeration system 740 which can generate cryogenic temperatures that are sufficient to operate components of the control system 720 for quantum computing applications. For example, the quantum processor 730 may need to be cooled down to near-absolute zero, e.g., 10-15 millikelvin (mK), to allow the superconducting qubits to exhibit quantum behaviors. In some embodiments, the dilution refrigeration system 740 comprises a multi-stage dilution refrigerator where the components of the control system 720 can be maintained at different cryogenic temperatures, as needed. For example, while the quantum processor 730 may need to be cooled down to, e.g., 10-15 mK, the circuit components of the control system 720 may be operated at cryogenic temperatures greater than 10-15 mK (e.g., cryogenic temperatures in a range of 3K-4K), depending on the configuration of the quantum computing system. In some embodiments, the entirety of the control system 720, or some components thereof, are disposed in a room temperature environment.

In some embodiments, the superconducting qubit array with tunable differential couplers 732 comprises a quantum system of superconducting qubits, superconducting qubit couplers, and other components commonly utilized to support quantum processing using qubits. The number of superconducting qubits of the superconducting qubit array with tunable differential couplers 732 can be on the order of tens, hundreds, thousands, or more, etc. The network 734 of qubit drive lines, flux bias control lines, coupler drive lines, and qubit state readout resonators, etc., is configured to apply microwave control signals to superconducting qubits and the tunable differential coupler circuitry in the superconducting qubit array to perform various types of gate operations, e.g., single-gate operations, entanglement gate operations, perform error correction operations, etc., as well as read the quantum states of the superconducting qubits. For example, microwave control pulses are applied to the qubit drive lines of respective superconducting qubits to change the quantum state of the superconducting qubits (e.g., change the quantum state of a given qubit between the ground state and excited state, or to a superposition state) when executing quantum information processing algorithms.

Furthermore, as noted above, the state readout lines comprise readout resonators that are coupled to respective superconducting qubits. The state of a given superconducting qubit can be determined through microwave transmission or reflection measurements using the readout ports of the readout resonator. The states of the superconducting qubits are read out after executing a quantum algorithm. In some embodiments, as noted above, a dispersive readout operation is performed in which a change in the resonant frequency of a given readout resonator, which is coupled to a given superconducting qubit, is utilized to readout the state (e.g., ground or excited state) of the given superconducting qubit.

The network 734 of qubit drive lines, flux bias lines, qubit coupler drive lines, qubit state readout resonators, etc., is coupled to the control system 720 through a suitable hardware input/output (I/O) interface, which couples I/O signals between the control system 720 and the quantum processor 730. For example, the hardware I/O interface may comprise various types of hardware and components, such as RF cables, wiring, RF elements, optical fibers, heat exchanges, filters, amplifiers, isolators, etc.

In some embodiments, the multi-channel arbitrary waveform generator (AWG) 722 and other suitable microwave pulse signal generators or flux-signal generators are configured to generate the microwave control pulses that are applied to the qubit drive lines, and the coupler drive lines to control the operation of the superconducting qubits and associated qubit coupler circuitry, when performing various gate operations to execute a given certain quantum information processing algorithm. In some embodiments, the multi-channel AWG 722 comprises a plurality of AWG channels, which control respective superconducting qubits within the superconducting qubit array and tunable differential couplers 732 of the quantum processor 730. In some embodiments, each AWG channel comprises a baseband signal generator, a digital-to-analog converter (DAC) stage, a filter stage, a modulation stage, an impedance matching network, and a phase-locked loop system to generate LO signals (e.g., quadrature LO signals LO_I and LO_Q) for the respective modulation stages of the respective AWG channels.

In some embodiments, the multi-channel AWG 722 comprises a quadrature AWG system which is configured to process quadrature signals, wherein a quadrature signal comprises an in-phase (I) signal component, and a quadrature-phase (Q) signal component. In each AWG channel the baseband signal generator is configured to receive baseband data as input (e.g., from the quantum computing platform), and generate digital quadrature signals I and Q which represent the input baseband data. In this process, the baseband data that is input to the baseband signal generator for a given AWG channel is separated into two orthogonal digital components including an in-phase (I) baseband component and a quadrature-phase (Q) baseband component. The baseband signal generator for the given AWG channel will generate the requisite digital quadrature baseband IQ signals which are needed to generate an analog waveform (e.g., sinusoidal voltage waveform) with a target center frequency that is configured to operate or otherwise control a given quantum bit that is coupled to the output of the given AWG channel.

The DAC stage for the given AWG channel is configured to convert a digital baseband signal (e.g., a digital IQ signal output from the baseband signal generator) to an analog baseband signal (e.g., analog baseband signals I(t) and Q(t)) having a baseband frequency. The filter stage for the given AWG channel is configured to filter the IQ analog signal components output from the DAC stage to thereby generate filtered analog IQ signals. The modulation stage for the given AWG channel is configured to perform analog IQ signal modulation (e.g., single-sideband (SSB) modulation) by mixing the filtered analog signals I(t) and Q(t), which are output from the filter stage, with quadrature LO signals (e.g., an in-phase LO signal (LO_I) and a quadrature-phase LO signal (LO_Q)) to generate and output an analog RF signal (e.g., a single-sideband modulated RF output signal).

The quantum computing platform 710 comprises a software and hardware platform which comprises various software layers that are configured to perform various functions, including, but not limited to, generating and implementing various quantum applications using suitable quantum programming languages, configuring and implementing various quantum gate operations, compiling quantum programs into a quantum assembly language, implementing and utilizing a suitable quantum instruction set architecture (ISA), performing calibration operations to calibrate the quantum circuit elements and gate operations, etc. In addition, the quantum computing platform 710 comprises a hardware architecture of processors, memory, etc., which is configured to control the execution of quantum applications, and interface with the control system 720 to (i) generate digital control signals that are converted to analog microwave control signals by the control system 720, to control operations of the quantum processor 730 when executing a given quantum application, and (ii) to obtain and process digital signals received from the control system 720, which represent the processing results generated by the quantum processor 730 when executing various gate operations for a given quantum application.

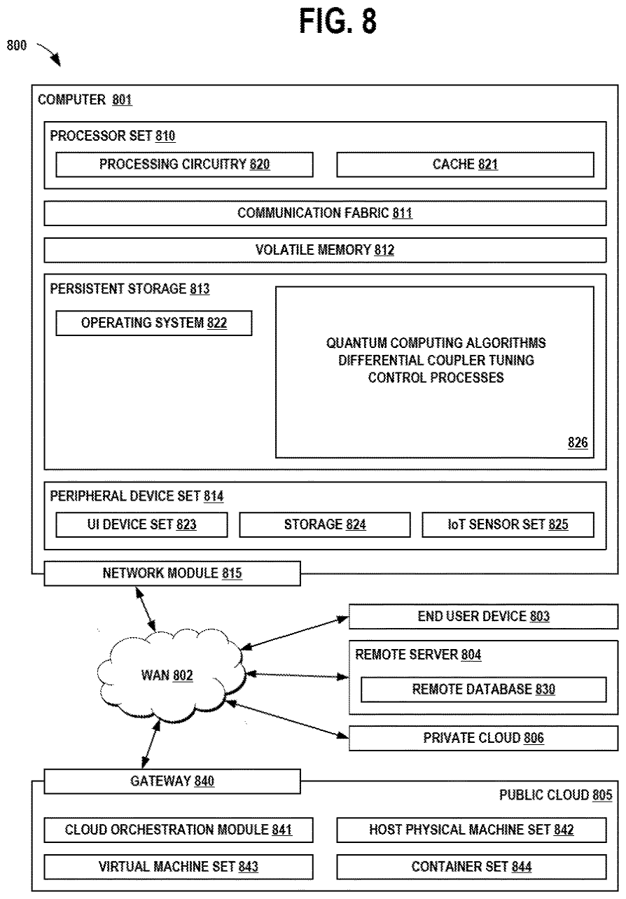

In some exemplary embodiments, the quantum computing platform 710 of the quantum computing system 700 may be implemented using any suitable computing system architecture (e.g., as shown in FIG. 8) which is configured to implement methods to support quantum computing operations by executing computer readable program instructions that are embodied on a computer program product which includes a computer readable storage medium (or media) having such computer readable program instructions thereon for causing a processor to perform control methods as discussed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 800 of FIG. 8 contains an example of an environment for the execution of at least some of the computer code (block 826) involved in executing quantum computing algorithms and differential coupling tuning control processes, as described herein. In addition to block 826, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 826, as identified above), peripheral device set 814 (including user interface (UI), device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

Computer 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

Processor set 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 826 in persistent storage 813.

Communication fabric 811 is the signal conduction path that allows the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 812 is any type of volatile memory now known or to be developed in the future. Examples include dynamic type random access memory (RAM) or static type RAM. Typically, the volatile memory is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

Persistent storage 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid-state storage devices. Operating system 822 may take several forms, such as various known proprietary operating systems or open source Portable Operating System Interface type operating systems that employ a kernel. The code included in block 826 typically includes at least some of the computer code involved in performing the inventive methods.

Peripheral device set 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

Network module 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

Remote server 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

Public cloud 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A device, comprising:
a superconducting quantum circuit comprising a coupler which is coupled to a first quantum bit and a second quantum bit, the coupler comprising a tunable coupler and a fixed coupler;
wherein the coupler is configured to operate in a first mode to suppress coupling between the first quantum bit and the second quantum bit, when the tunable coupler is tuned to have a first frequency which corresponds to a fixed frequency of the fixed coupler; and
wherein the coupler is configured to operate in a second mode to enable coupling between the first quantum bit and the second quantum bit, when the tunable coupler is tuned to have a second frequency which is different from the fixed frequency of the fixed coupler.

2. The device of claim 1, wherein in the second mode, the second frequency of the tunable coupler corresponds to a transition frequency of the first quantum bit or the second quantum bit.

3. The device of claim 1, wherein the coupler is configured to suppress a direct capacitive coupling between the first quantum bit and the second quantum bit, when the coupler operates in the first mode or the second mode.

4. The device of claim 1, wherein:
in the first mode, the coupler is configured to suppress the coupling between the first quantum bit and the second quantum bit through cancellation of coupler-qubit couplings of the tunable and fixed couplers with the first and second quantum bits; and
in the second mode, the coupler is configured to enable coupling between the first quantum bit and the second quantum bit through a net effective coupler-qubit coupling of the tunable and fixed couplers with the first and second quantum bits.

5. The device of claim 1, wherein:
the tunable coupler is capacitively coupled to a differential mode of the first quantum bit with a first polarity, and to a differential mode of the second quantum bit with the first polarity; and
the fixed coupler is capacitively coupled to the differential mode of the first quantum bit with the first polarity, and to the differential mode of the second quantum bit with a second polarity, which is opposite the first polarity.

6. The device of claim 1, wherein:
the fixed coupler is capacitively coupled to a differential mode of the first quantum bit with a first polarity, and to a differential mode of the second quantum bit with the first polarity; and
the tunable coupler is capacitively coupled to the differential mode of the first quantum bit with the first polarity, and to the differential mode of the second quantum bit with a second polarity, which is opposite the first polarity.

7. The device of claim 1, wherein:
the tunable coupler is implemented with a flux-tunable quantum bit coupler; and
the fixed coupler is implemented with a fixed frequency quantum bit coupler.

8. A device, comprising:
a superconducting quantum circuit comprising a coupler, a first quantum bit, and a second quantum bit;
wherein the coupler comprises:
a tunable coupler which is differentially coupled to the first quantum bit, and differentially coupled to the second quantum bit; and
a fixed coupler which is differentially coupled to the first quantum bit, and differentially coupled to second quantum bit;
wherein one of the tunable coupler and the fixed coupler is differentially coupled to the first quantum bit and to the second quantum bit with opposite polarities, and the other of the tunable coupler and the fixed coupler is differentially coupled to the first quantum bit and to the second quantum bit with a same polarity.

9. The device of claim 8, wherein:
the coupler is configured to operate in a first mode to suppress coupling between the first quantum bit and the second quantum bit, when the tunable coupler is tuned to have a first frequency which corresponds to a fixed frequency of the fixed coupler; and
the coupler is configured to operate in a second mode to enable coupling between the first quantum bit and the second quantum bit, when the tunable coupler is tuned to have a second frequency which is different from the fixed frequency of the fixed coupler.

10. The device of claim 9, wherein in the second mode, the second frequency of the tunable coupler corresponds to a transition frequency of first quantum bit or the second quantum bit.

11. The device of claim 9, wherein the coupler is configured to suppress a direct coupling between the first quantum bit and the second quantum bit, when the coupler operates in the first mode or the second mode.

12. The device of claim 9, wherein:
in the first mode, the coupler is configured to suppress the coupling between the first quantum bit and the second quantum bit through cancellation of coupler-qubit couplings of the tunable and fixed couplers with the first and second quantum bits; and
in the second mode, the coupler is configured to enable coupling between the first quantum bit and the second quantum bit through a net effective coupler-qubit coupling of the tunable and fixed couplers with the first and second quantum bits.

13. The device of claim 8, wherein:
the tunable coupler comprises a flux-tunable quantum bit coupler; and
the fixed coupler comprises a fixed frequency quantum bit coupler.

14. A system, comprising:
a superconducting quantum circuit comprising a coupler which is coupled to a first quantum bit and a second quantum bit, the coupler comprising a tunable coupler and a fixed coupler; and
a control system which is configured to cause the coupler to operate in one of a first mode and a second mode;
wherein in the first mode, the control system causes the tunable coupler to have a have a first frequency which corresponds to a fixed frequency of the fixed coupler, to thereby suppress a coupling between the first quantum bit and the second quantum bit; and
wherein in the second mode, the control system causes the tunable coupler to have a second frequency which is different from the fixed frequency of the fixed coupler, to thereby enable a coupling between the first quantum bit and the second quantum bit.

15. The system of claim 14, wherein in the second mode, the second frequency of the tunable coupler corresponds to a transition frequency of one of the first quantum bit and the second quantum bit.

16. The system of claim 14, wherein the coupler is configured to suppress a direct coupling between the first quantum bit and the second quantum bit, when the coupler operates in the first mode or the second mode.

17. The system of claim 14, wherein:
in the first mode, the coupler is configured to suppress the coupling between the first quantum bit and the second quantum bit through cancellation of coupler-qubit couplings of the tunable and fixed couplers with the first and second quantum bits; and
in the second mode, the coupler is configured to enable coupling between the first quantum bit and the second quantum bit through a net effective coupler-qubit coupling of the tunable and fixed couplers with the first and second quantum bits.

18. The system of claim 14, wherein:
the tunable coupler is capacitively coupled to a differential mode of the first quantum bit with a first polarity, and to a differential mode of the second quantum bit with the first polarity; and
the fixed coupler is capacitively coupled to the differential mode of the first quantum bit with the first polarity, and to the differential mode of the second quantum bit with a second polarity, which is opposite the first polarity.

19. A system, comprising:
a quantum processor comprising a lattice of superconducting quantum bits and couplers that are configured to control interactions between the superconducting quantum bits; and
a control system configured to generate control signals for controlling the superconducting quantum bits and for controlling the couplers;
wherein the superconducting quantum bits and the couplers comprise at least one coupler which is coupled to at least a first quantum bit and a second quantum bit, and which comprises a tunable coupler and a fixed coupler;
wherein the at least one coupler is configured to operate in a first mode to suppress coupling between the first quantum bit and the second quantum bit, when the tunable coupler is tuned in response to a first control signal from the control system to have a first frequency which corresponds to a fixed frequency of the fixed coupler; and
wherein the at least one coupler is configured to operate in a second mode to enable coupling between the first quantum bit and the second quantum bit, when the tunable coupler is tuned in response to a second control signal from the control system to have a second frequency which is different from the fixed frequency of the fixed coupler.

20. The system of claim 19, wherein in the second mode, the second frequency of the tunable coupler corresponds to a transition frequency of the first quantum bit or the second quantum bit.

21. The system of claim 19, wherein the at least one coupler is configured to suppress a direct capacitive coupling between the first quantum bit and the second quantum bit, when the at least one coupler operates in the first mode or the second mode.

22. The system of claim 19, wherein:
in the first mode, the at least one coupler is configured to suppress the coupling between the first quantum bit and the second quantum bit through cancellation of coupler-qubit couplings of the tunable and fixed couplers with the first and second quantum bits; and
in the second mode, the at least one coupler is configured to enable coupling between the first quantum bit and the second quantum bit through a net effective coupler-qubit coupling of the tunable and fixed couplers with the first and second quantum bits.

23. The system of claim 19, wherein one of: (i) the tunable coupler is capacitively coupled to a differential mode of the first quantum bit with a first polarity, and to a differential mode of the second quantum bit with the first polarity; and the fixed coupler is capacitively coupled to the differential mode of the first quantum bit with the first polarity, and to the differential mode of the second quantum bit with a second polarity, which is opposite the first polarity, and (ii) the fixed coupler is capacitively coupled to the differential mode of the first quantum bit with the first polarity, and to the differential mode of the second quantum bit with the first polarity; and the tunable coupler is capacitively coupled to the differential mode of the first quantum bit with the first polarity, and to the differential mode of the second quantum bit with the second polarity, which is opposite the first polarity.

24. A method, comprising:
tuning a coupler to operate in one of a first mode and a second mode to control an amount of coupling between a first quantum bit and a second quantum bit, the coupler comprising a tunable coupler and a fixed coupler;
wherein tuning the coupler to operate in the first mode comprises tuning the tunable coupler to have a first frequency which corresponds to a fixed frequency of the fixed coupler to suppress the coupling between the first quantum bit and the second quantum bit; and
wherein tuning the coupler to operate in the second mode comprises tuning the tunable coupler to have a second frequency which is detuned from the fixed frequency of the fixed coupler to enable a coupling between the first quantum bit and the second quantum bit.

25. The method of claim 24, wherein the coupler is configured to suppress a direct coupling between the first quantum bit and the second quantum bit, when the coupler operates in the first mode or the second mode.
